(19) United States
(12) Patent Application Publication
(10) Pub. No.: US 2024/0166269 A1
(43) Pub. Date: May 23, 2024

(54) Instrument Panel Carrier For A Motor Vehicle

(71) Applicant: Kirchhoff Automotive Deutschland GmbH, Attendorn (DE)

(72) Inventors: Alexander Günther, Olpe (DE); Dominik Tentscher, Hemer (DE)

(21) Appl. No.: 18/551,288

(22) PCT Filed: Apr. 29, 2022
(86) PCT No.: PCT/EP2022/061560

§ 371 Date: Sep. 19, 2023

(30) Foreign Application Priority Data
Apr. 30, 2021 (DE) 10 2021 111 222.2

(51) Int. Cl. B62D 25/14

(52) U.S. Cl. CPC B62D 25/145

(57) ABSTRACT

The invention relates to an instrument panel carrier (1) for a motor vehicle, comprising a transverse member (2) which extends substantially in the transverse direction and has a connecting strut (3) protruding from the transverse member (2), to which connecting strut the steering column of the motor vehicle can be attached, and which connecting strut is attached via a first connecting portion (6) to the instrument panel carrier (1) and can be attached via a second connecting portion (8) to an end wall that frontally delimits the passenger compartment of the motor vehicle.

The special characteristic is that the connecting strut (3) is attached to the instrument carrier panel (1) via a deformation joint (17) which acts about the vertical axis of the motor vehicle.

The invention relates to an instrument panel carrier for a motor vehicle, comprising a transverse member which extends substantially in the transverse direction and has a connecting strut protruding from the transverse member and having a base region, to which connecting strut the steering column of the motor vehicle can be attached and which is connected to the instrument panel carrier via a first connecting portion and can be connected via a second connecting portion to an end wall that frontally delimits the passenger compartment of the motor vehicle.

Instrument panel carriers are designed as transverse members that are arranged between the two A-pillars of a motor vehicle. Various units, the pedals, displays and the steering column are connected to the instrument panel carrier. Such instrument panel carriers are also referred to as cross car beams.

The steering column is connected to the transverse member of such an instrument panel carrier by means of a connecting strut projecting from the transverse member. Special requirements are placed on the connecting strut: On the one hand, the steering column connection must be sufficiently stiff so that a direct steering feel is possible. On the other hand, any vibrations generated by a motor driving the motor vehicle, such as an internal combustion engine, should not be transmitted to the steering column module and thus to the steering wheel. In addition, tensile and compressive forces as well as bending moments must be transmitted when a driver pulls himself up on the steering wheel or supports himself in the event of a crash.

When installed in a motor vehicle, the connecting strut for the steering column is also connected to an end wall separating the passenger compartment on the front side. In a front engine vehicle, the end wall separates the passenger compartment from the engine compartment. In this way, the connecting strut is supported on the transverse member and on the end wall, typically at its distal ends.

Such an instrument panel carrier is known, for example, from CN 207106645 U. A transverse member designed as a hollow chamber profile is disclosed, to which a solid connecting strut is connected. The solid connection to the transverse member is characterized by a wide, clamp-like connecting portion that almost completely encompasses the periphery of the transverse member. The connecting portion on the end wall is kept significantly smaller than the connecting portion on the transverse member.

CN 107433970 A discloses a combined connecting strut, comprising a strut to which an end wall can be connected and one to which a steering column can be connected. The connecting portion of this combined connecting strut is also solid.

A similar concept is also disclosed in CN 202728361 U. Here, too, the connecting strut is solidly connected to the transverse member.

JP 2016 193 680 A discloses a connecting strut complex through which a transverse member is connected to the end wall via two parallel struts. Due to the massive design and the double support, there is a firm connection in this case.

In the case of these previously known instrument panel carriers, the connecting strut is regularly solidly connected to the transverse member in order not to be deformed in the transverse direction in the event of a side crash.

DE 36 24 747 A1 discloses a guide strut, which is intended to support the steering column in a specific direction in the event of a crash and is thus designed with a kink point. A similar disclosure is also shown in JP 2000 1808 940 and JP 2009 012 564 A.

The problem with this prior art is that these configurations basically meet the side crash requirements. However, it must be accepted that the instrument panel carrier, or its transverse member, bulges or buckles in the direction of the passenger compartment due to a laterally applied force in the passenger region. This can be observed in particular in those instrument panel carriers in which the transverse member between the driver's side and the passenger's side has a portion that is offset relative to the main longitudinal extent.

Against this background, there is a desire for an instrument panel carrier in which deformation of the transverse member on the passenger side is reduced, if not avoided altogether, in the event of a lateral crash.

This object is achieved by an instrument panel carrier of the type mentioned at the outset with the further features of claim 1. Advantageous refinements result from the dependent claims and the description.

In these embodiments, it is defined that the front direction corresponds to the longitudinal direction (x-direction), the transverse direction to the width direction (y-direction), and the vertical direction to the height of a motor vehicle (z-direction).

The essence of the invention is to provide a connecting strut that connects the transverse member, the end wall and the steering column or the steering column module to one another. This strut is designed in such a way that it forms a deformation joint. This deformation joint acts in the vertical direction of the motor vehicle (z-direction), so that in the event of a side crash, the connecting strut or a portion thereof can be pivoted about the vertical axis relative to the transverse member. This pivotability is provided by a plastic deformation in the region of the first connection region. The angle between the longitudinal extent of the transverse member and a connecting line between the connection point on the transverse member side and the connection point on the end wall side of the connecting strut should be variable in the event of a side crash. Plastic deformations require a certain energy input from the side crash.

The deformation joint provides its articulation through plastic deformation. The connecting strut can only break off from the transverse member under the influence of very high forces. In the case of a typical side crash force, the deformation joint should deform according to a target deformation point.

In this way, the transverse member is decoupled from the connecting strut in the event of a side crash, so that the end wall and transverse member can be adjusted in relation to one another in the transverse direction (y-direction). Thus, the end wall and transverse member can be deformed independently of one another, wherein the mutual influence of the respective deformation on the two parts can be minimized. In this way, buckling or caving of the transverse member can be reduced by 20-30 mm or more, depending on the design of the instrument panel carrier.

In order to increase this effect, it can be provided that the end wall is also connected to the connecting strut by means of such a deformation joint.

In addition, an embodiment with at least one deformation joint is also advantageous in the event of a frontal crash. In the case of a frontal crash, the end wall in the cockpit region, starting from the front end, is displaced in the longitudinal direction of the vehicle.

Efforts to achieve a high level of passenger safety also require the least possible intrusion of the cockpit components in the longitudinal direction of the vehicle in the event of a frontal crash. In this context, the displacement of the end wall should not lead to a displacement of the transverse member in the longitudinal direction of the vehicle. The envisaged embodiment achieves this goal, since it also has a yielding range for forces in the longitudinal direction of the vehicle due to the deformation joint.

The rigidity of the connecting strut required for connecting the steering column can nevertheless be guaranteed. This can be achieved, for example, by supporting the connecting strut relative to the end wall in a vibration-optimized manner. This can be done by providing reinforcements and/or material cutouts in portions. In addition or as an alternative, it can be provided that the connection of the connecting strut to the end wall is designed in such a way that the connection region itself is designed to be rigid, but is connected to the end wall with a tolerance compensation element. If the tolerance compensation element is narrow with a small cross section, forces can be transmitted in all directions and a torque can be transmitted in the plane of the end wall; it is nevertheless possible for the connecting strut to pivot in relation to the end wall in the event of a crash. Due to the pivoting, fewer vibrations are transmitted from the end wall into the connecting strut or the steering column: due to the relatively long distance between the second connecting region of the connecting strut and the steering wheel in relation to the distance between the first connecting region and the steering wheel—which forms the rotation point for a possible oscillation originating from the end wall—the vibration amplitude on the steering wheel is kept small so that the vibrations are no longer noticeable, at least not unpleasant.

In order to form the deformation joint between the transverse member and the connecting strut, it can be provided that the connecting strut has its lowest transverse section modulus in the region of the first connecting portion. This can be achieved by a targeted geometric softening of this region compared to the rest of the adjoining region in order to provide the desired target deformation point. A reduced cross-section in this region weakens the same, so that it buckles when a force is applied from the side.

Provision can be made for the high section modulus to be greater in comparison, in order to provide the required rigidity.

According to another embodiment, it is provided that the first connecting portion is significantly narrower than the length of the connecting strut between the transverse member and the end wall. This ensures that the lever arm in the direction of the end wall is greater than the width of the connection to the transverse strut.

A further possibility is that the cross section of the connecting strut increases in the transverse direction in the direction of longitudinal extent, pointing away from the transverse member. In this way, a connecting strut with a V-shaped base surface is provided, with the second connecting portion representing the wider side. The transverse section modulus thus increases gradually, preferably continuously, in the direction of longitudinal extent in order to avoid notch effects. Immediately adjacent to the transverse member, this connecting strut thus has its lowest transverse load capacity, as a result of which the deformation joint is formed.

A particular advantage of such a connecting strut is that it allows great design freedom in the dimensioning and design of the deformation joint. This can therefore be optimally designed not only with regard to the side crash requirements, but also with regard to the aspects of vibration damping and the lightest possible weight for the respective vehicle type.

For softening, it can also be provided that the region provided for the deformation joint is subjected to a heat treatment.

In the above mentioned possible designs for forming the deformation joint, the transverse member forms the required abutment.

An L or U profile is preferably provided as the connecting strut, which is open in the z direction (up or down). It can also be provided that the connecting strut is designed in the manner of an L-profile, but the side opposite the short leg of the profile is also beveled, wherein this additional beveled leg has only a small height compared to the height of the other leg. This improves the vibration performance through stiffening while at the same time reducing material requirements. Such a profile is also to be regarded as an L-profile in the context of these statements.

Provision can be made for the base region of the connecting strut, namely the region pointing in the direction of the vertical axis (z-direction), to have a framework structure. Triangular recesses can be introduced into the base region, typically by punching them out, with intermediate webs, each arranged at an angle to one another. The triangles are designed with rounded comers to avoid notch effects. In this way, material can be saved and weight can be reduced in this way. Cable harnesses or similar lines can also be passed through these openings. Surprisingly, it has been shown that such a framework structure is particularly useful for forming a deformation joint, wherein the connecting strut also having the required rigidity for connecting a steering column. Even with such a framework structure in the base region of the connecting strut, the deformation joint can be defined in terms of its position and its behavior in the event of a crash.

Recesses can also be provided in the leg(s) of the connecting strut designed as a profile in cross section, preferably in a framework structure. This is particularly useful in the region in which the deformation joint is provided.

The connection of the connecting strut to the transverse member can be offset in the transverse direction compared to the connection of the connecting strut to the end wall. An imaginary connecting line between the two connections of the connecting strut relative to the longitudinal extent of the transverse member is therefore at an angle different from 90°. In this way, a force flow acts between the two connections, which can also transmit a force component in the transverse direction. Due to the fact that the connecting strut does not connect the transverse member and the end wall on the shortest connecting line, the transverse member can be supported on the end wall in the event of a side crash and possibly also deform therewith. As a result of this deformation, any rotation point on the end wall that would cause the transverse member to bulge or buckle is also displaced, so that bulging or buckling is also effectively prevented in this way.

It is preferably provided that the connection to the end wall is offset in relation to the connection to the transverse member in the direction of the center—in relation to the longitudinal extent—of the transverse member: a side crash from the driver's side is particularly relevant for the problem described above. The forces introduced in this way are introduced directly into the connecting strut. If the two connections are arranged in relation to one another in such a way that the connecting strut can transmit part of the side impact force introduced from the driver's side, this is positive for the overall crash performance.

For the effective connection of a steering column, provision is preferably made for at least one, preferably two or more connection points to be provided in the region of the second connecting portion and thus in the vicinity of the end wall. In the connecting strut proposed here, the part pointing to the end wall is stiffened, specifically more stiffened than the other portions of the connecting strut.

In order to improve the connection of the steering column, it can be provided that a steering column connection region, in which the at least one connection point for the steering column is provided, adjoins the second connecting portion in the longitudinal extension of the connecting strut. This is joined to the remaining part of the connecting strut. The second connecting portion and the steering column connection region are jointly stiffened by a stiffening structure in relation to the remaining part. Since the two regions are mutually rigid with respect to all axes and torques compared to the remaining part of the connecting strut, the forces introduced into the steering column can be transmitted particularly effectively to the second connecting region.

The aforementioned stiffening structure can be formed, for example, by walls connected to one another, which form a frame surrounding the at least one connection point for the steering column. The end wall can also be connected to one of the walls of this frame or this frame structure. The frame structure provides a stiffening structure that is particularly easy to produce but at the same time very effective. The stiffening structure can be part of the plate from which the connecting strut is formed.

A separate stiffening part is preferably provided for the design of the stiffening structure. This stiffening part can also have a greater material thickness than the connecting strut itself. In this way, the stiffening can take place effectively and also according to different boundary conditions. Such a stiffening part is typically joined to the connecting strut by welding. It is entirely possible to use one leg of the connecting strut as a wall, so that the stiffening structure is formed by this wall portion and a U-shaped stiffening part. For an optimal introduction of force into the end wall, it is also preferably provided that the wall of the frame structure, which corresponds to the distal end of the connecting strut, is used to connect the end wall.

Although the frame may have any number of corners, a square shape is particularly contemplated.

If the connecting strut is an L-profile (wherein—as explained above—a U-profile with limbs of different heights is regarded as an L-profile), it can be provided that a wall of the stiffening structure is formed by a limb, typically the shorter limb of the connecting strut and the remaining walls are provided by a separate stiffening part. The stiffening part then has a web and two legs connected thereto, the end faces of the legs pointing towards the leg of the connecting strut. The stiffening part is bonded to the connecting strut, typically by welding, in order to ensure the required rigidity. It makes sense to position the weld seam essentially over the entire length of the walls. This improves the vibration performance. In addition, the weld seam is protected against fatigue fracture.

The first connection region of the connecting strut can be designed as a transverse member receptacle. In this way, a positive connection is created between the connecting strut and the transverse member, which is conducive to any power transmission. To further improve the vibration performance, it is provided to weld the transverse member to the transverse member receptacle of the connecting strut. The transverse member receptacle surrounds the transverse member at least over an angle from the longitudinal extension of the connecting strut to perpendicular thereto. The transverse member receptacle preferably surrounds the transverse member over approximately 180°. With such a configuration, the weld seam can be made correspondingly long, which also has a positive effect on the vibration performance. The weld seam length can also be selected to achieve the desired vibration performance by selecting the angle of grip of the transverse member receptacle.

In order to support the steering column, it is also provided that a steering column connection point is also provided in the first connecting portion.

Overall, it can be provided that a connection point for a steering column is provided in the region of the first connecting portion and two steering column connection points are provided in the region of the second connecting portion. A fourth connection can be provided on a separate component. By providing three steering column connection points on one and the same component, a particularly high degree of dimensional accuracy of the connection points with regard to their alignment with one another is possible.

Provision is preferably made for the connecting strut to be made of metal, typically steel or an aluminum alloy suitable for this purpose. To form the deformation joint, however, provision can also be made for the component to be made from different materials in the sense of tailored blanks.

The invention is explained in more detail in the following with reference to the appended figures. In the figures:

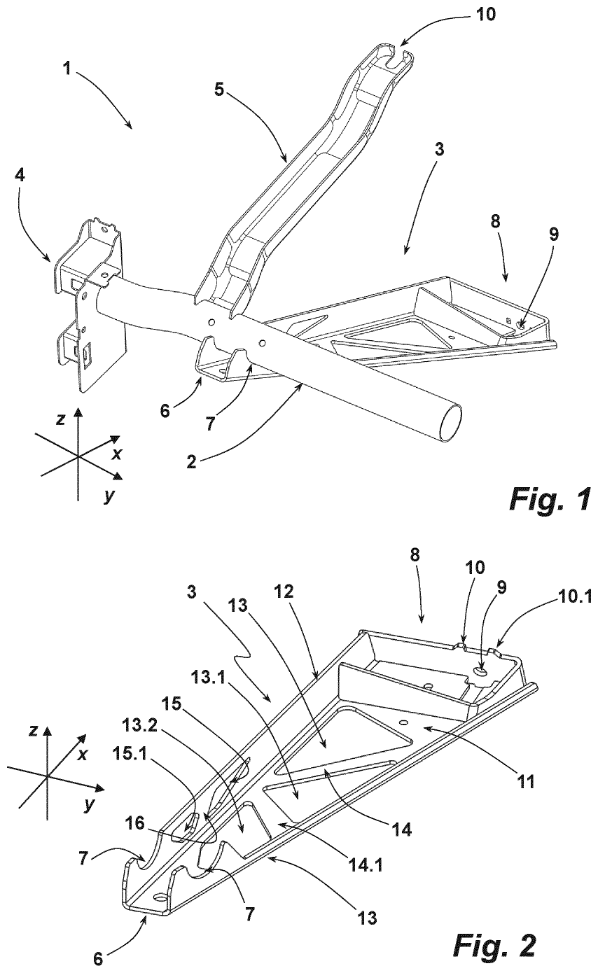

FIG. 1: shows portion of an instrument panel carrier with a connecting strut,

FIG. 2: shows the connecting strut of the instrument panel carrier of FIG. 1 in a perspective view,

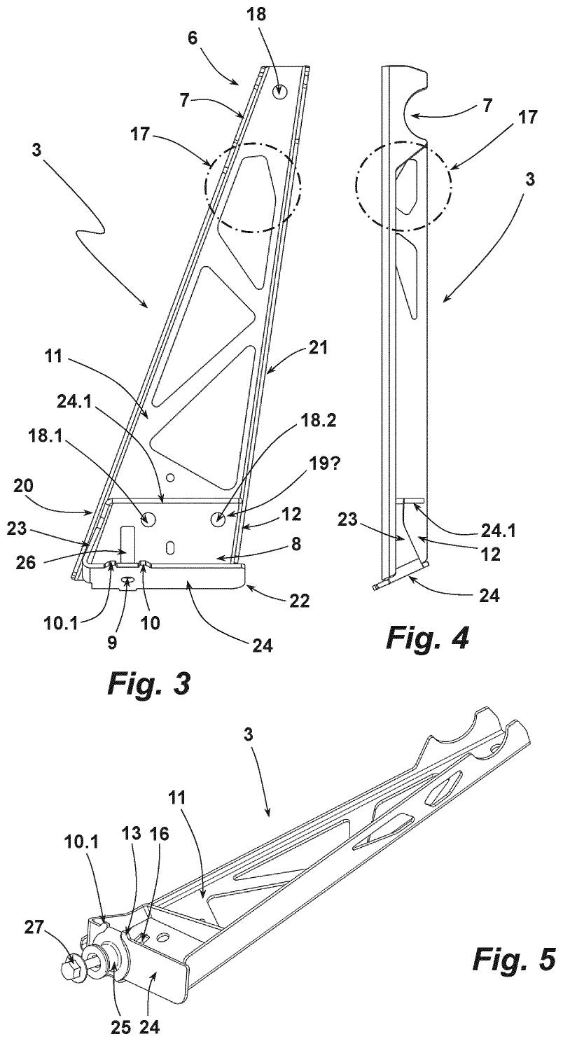

FIG. 3: shows the connecting strut according to FIG. 2 in a plan view,

FIG. 4: shows the connecting strut according to FIG. 2 in a side view on the left side of the representation of the connecting strut of FIG. 2,

FIG. 5: shows the connecting strut according to the above figures with an attached tolerance compensation element,

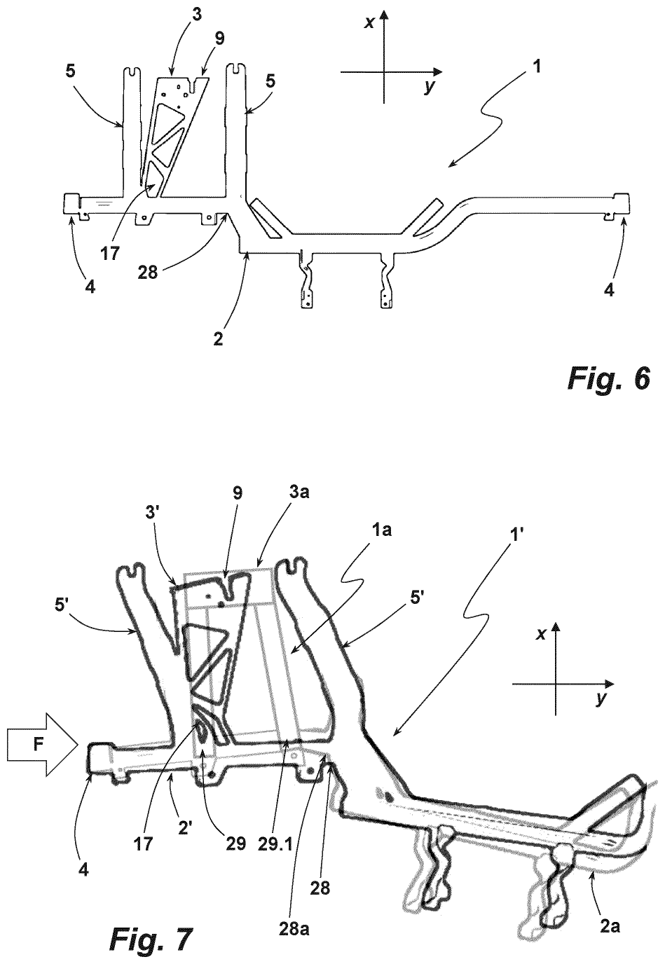

FIG. 6: shows a schematic plan view of the instrument panel carrier according to the invention in an installation situation,

FIG. 7: shows a portion of the instrument panel carrier shown in FIG. 6 after a side crash (black lines) in a comparison with an instrument panel carrier according to the prior art (gray lines) and

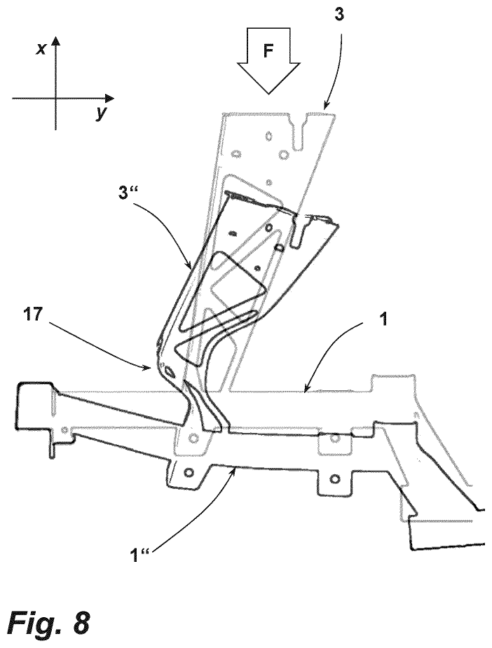

FIG. 8: shows a schematic plan view of the instrument panel carrier according to the invention in an installation situation (gray lines) in a comparison with an instrument panel carrier after a frontal crash (black lines).

A coordinate system is partially drawn in the figures. The y-direction corresponds to the transverse axis, the x-direction to the longitudinal axis and the z-direction to the vertical axis of a motor vehicle in the usual nomenclature.

FIG. 1 shows an instrument panel carrier 1 in its driver-side portion. The instrument panel carrier 1 comprises a transverse member 2 and a connecting strut 3 connected to the transverse member 2 and protruding from it in the x-direction. The connecting strut 3 is used to connect a steering column or a steering column module and to connect the transverse member to a motor vehicle-side end wall, not shown in the figures, as a frontal boundary of the passenger compartment. The transverse member 2 is connected on both sides with connection elements 4 (only the left side visible in FIG. 1) to A-pillars (not shown in detail) of a motor vehicle (also not shown in detail). Furthermore, a support strut 5 is connected to the instrument panel carrier 2.

The connecting strut 3 has a first connecting portion 6 with which it is connected to the transverse member 2. The first connecting portion 6 is designed as a transverse member receptacle 7 enclosing the transverse member 2. The connecting strut 3 is welded to the weld seams along the transverse member receptacle 7. Both the transverse member 2 and the connecting strut 3 are designed as steel components in the exemplary embodiment shown.

The connecting strut 3 also has a second connecting portion 8, with which it is connected to an end wall, which is not shown in detail and delimits the front of the passenger compartment. A connection point 9 is provided for connecting the end wall to the connecting strut 3. In the exemplary embodiment shown, the connection point 9 is implemented as a hole for inserting a connection fastener. The support strut 5 connected to the transverse member 2 also has a connection region 10. The end wall can be connected thereto. It is also possible to use the support strut 5 as a holder for units, for example a display.

A steering column, not shown in detail, can be connected to the underside of the connecting strut 3.

FIG. 2 shows the connecting strut 3 in a separate perspective view. This connecting strut 3 is virtually identical to that shown in FIG. 1; only two tolerance compensation edging lugs 10, 10.1 are additionally provided. For this reason, the same reference symbols as in FIG. 1 are otherwise used in this figure.

The connecting strut 3 of the exemplary embodiment shown is designed as an L profile when viewed in cross section. The L-profile comprises a base region 11 pointing in the direction of the vertical axis and a leg 12 connected to it. The side opposite the short leg 12 of the L-profile is beveled, so that on this side of the connecting strut there is a leg opposite leg 12, which is very short in terms of its height.

The base region 11 has a framework structure, formed from recesses 13, 13.1, 13.2 and webs 14, 14.1 arranged in between. The connecting strut 3 is V-shaped in that it is narrower in the transverse direction at its first connecting portion 6 than at its second connecting portion 8. Immediately adjacent to the connecting region 6, with which it is connected to the transverse member 2, the connecting strut 3 has its smallest transverse section modulus, which is additionally reduced by the recess 13.2 in the base region 11 adjacent to the first connection region 6 in addition to the configuration which is narrow compared to the second connecting portion. Furthermore, this region of the connecting strut 3 is weakened by a framework structure in the leg 12, provided by the recesses 15, 15.1 and the interposed web 16. In this way, a deformation joint 17 is provided in this region. This region of the connecting strut 3 is shown in FIG. 3. In the region of the deformation joint 17, the connecting strut 3 is designed to be weaker with respect to transverse loading than in the other portions. In this way, the connecting strut 3 connected to the transverse member 2 can be plastically deformed in the deformation joint 17 in the event of a side crash. The active direction of the deformation joint 17 is provided around the vertical axis.

The connection of the connecting strut 3 to the transverse member—here in the form of the transverse member receptacle 7—is offset in the transverse direction (y-direction) towards the center of the transverse member compared to the connection to the end wall—here the connection point 9 (see also FIG. 1).

FIG. 3 shows the connecting strut 3 described above in a plan view. In this view, the steering column connections 18, 18.1, 18.2 introduced into the base 11 can be seen in particular. A single steering column connection point 18 is provided in the first connecting portion 6. The second connection region 8 is immediately followed by a steering column connection region 19 with two steering column connection points 18.1, 18.2.

The steering column connection region 19 and the second connecting portion 8 are surrounded by a box-shaped frame structure as a stiffening structure 20 and are stiffened in this way in relation to the remaining part 21 of the connecting strut 3. The stiffening structure 20 is formed by the end portion of the leg 12 as the first wall and by a separate reinforcement part 22 which is U-shaped in plan view and comprises a web 23 and two legs 24, 24.1 connected thereto. The web 23 and the legs 24, 24.1 have a greater material thickness than the L-profile of the connecting strut 3. The stiffening part 22 is welded to the base region 11 and via the end face of the leg 24.1 to the leg 12 of the L-profile over the entire length.

The stiffening part 22 has, with its leg 24 pointing towards the end wall (not shown in more detail), a surface on which an end wall can be supported. The connection point 9 for the support against an end wall is provided in this leg 24.

The end wall does not adjoin the connecting strut 3 at right angles, as can be clearly seen in FIG. 4. The web 23 is formed in accordance with the position of the leg 24 caused by the inclination. Its height is reduced towards the leg 24.1. The second connection region 8 is sufficiently stiffened by the stiffening structure 20 without having to use excessive material for this purpose.

FIG. 5 shows the connecting strut 3 with a tolerance compensation element 25 mounted at the connection point 9. The tolerance compensation element 25 has a retaining clip to hold it on the leg 24. A retaining clip portion engages behind the wall 24 on the upper side between the two tolerance compensation element mounting lugs 10, 10.1. The wall 24 is gripped from below with a second clip portion. Due to the position of the leg 24 pointing towards the end wall, the base region 11 has a recess 26 into which a screw 27 guided through the tolerance compensation element 25 can engage. With this tolerance compensation element 25, the end wall is connected to the connecting strut 3a. The tolerance compensation element 25 has two elements that can be adjusted in relation to one another, by means of which the effective longitudinal extension of the tolerance compensation element 25 can be set up. In this way, the desired tolerance compensation takes place between an end wall and the end of the connecting strut 3 pointing towards the end wall.

FIG. 6 and FIG. 7 show an analysis of the crash behavior of an instrument panel carrier 1, 1′ according to the invention. FIG. 6 shows the initial state and thus the intact, undeformed instrument panel carrier 1. FIG. 7 shows the state after a side crash. The instrument panel carrier deformed by the side crash is identified therein by the reference number 1′. An instrument panel carrier 1a according to the prior art is shown in gray in FIG. 7 for comparison.

FIG. 6 shows the instrument panel carrier 1, which is connected at its distal ends with connection elements 4 to the A-pillars of a motor vehicle, not shown in detail.

Due to its shape, the transverse member 2 has a potential buckling point 28 along its longitudinal extension. This is due to the cranking of the course of the transverse member 2 in the direction of the passenger cell, which is not shown in detail, which can be seen in FIG. 6.

FIG. 7 shows the instrument panel carrier 1 in a deformed state 1′ as a result of a side crash force F. It can be clearly seen that the angle between the longitudinal extension of the connecting strut 3′ and that of the transverse member 2′ has changed—the deformation joint 17 has been plastically deformed. The transverse member 2′ has been displaced in a hinge-like manner relative to the connecting strut 3′ about the axis of the deformation joint 17′. As a result of the plastic deformation of the deformation joint 17′, the transverse member 2′ is not particularly buckled at its potential buckling point 28.

The advantages of the instrument panel carrier 1 according to the invention over previously known ones become clear in a comparison with an instrument panel carrier 1a according to the prior art. The connecting strut 3a of this comparative instrument panel carrier 1a is solidly connected to an end wall, not shown in detail, by means of two webs 29, 29.1, as described at the beginning with regard to the prior art. Due to the web 29.1, the transverse member 2a buckled much more strongly at the potential buckling point 28a as a result of a side crash, since it was pulled against the end wall by this web 29.1. The transverse member 2a is therefore more twisted about the vertical axis. It is easy to see that, in the event of a side crash, the instrument panel carrier 1′ according to the invention has been rotated less far into the passenger compartment than the instrument panel carrier 1a.

FIG. 8 shows a detail of the instrument panel carrier 1 in the installation situation and in a deformed state 1″ as a result of a frontal crash with force F. It can be clearly seen that the connecting strut 3″ in the deformation joint 17 has plastically deformed and thus has absorbed kinetic energy. This prevents the instrument panel carrier from intruding into a passenger compartment.

The invention has been described on the basis of exemplary embodiments. Numerous further embodiments for implementing the inventive concept without departing from the scope of the invention set out in the claims are apparent to a person skilled in the art, without these having to be explained in greater detail in the context of these explanations.

### LIST OF REFERENCE NUMERALS

1, 1′, 1″, 1a instrument panel carrier
2, 2′, 2a transverse member
3, 3′, 3″, 3a connecting strut
4 connecting element
5,5′ support strut
6 first connecting portion
7 transverse member receptacle
8 second connecting portion
9 connection point for end wall
10, 10.1 tolerance compensation element grip nose
11 base region
12 leg
13, 13.1, 13.2 recess in base region
14, 14.1 web in base region
15, 15.1 recess in leg
16 web in leg
17 deformation joint
18, 18.1, 18.2 steering column connection point
19 steering column connection region
20 stiffening structure
21 remaining part
22 stiffening part
23 web
24, 24.1 leg
25 tolerance compensation element
26 recess
27 screw
28, 28a kink
29, 29.1 web
F side crash force

1. An instrument panel carrier (1) for a motor vehicle, comprising a transverse member (2) extending substantially in the transverse direction with a connecting strut (3) protruding from the transverse member (2) and having a base region (11), to which the steering column of the motor vehicle can be connected and which is connected with a first connecting portion (6) to the instrument panel carrier (1) and with a second connecting portion (8) to an end wall delimiting the passenger compartment of the motor vehicle, characterized in that the base region (11) of the connecting strut (3) points in the direction of the vertical axis and a deformation joint (17) acting around the vertical axis of the motor vehicle is provided by the connecting strut (3).

2. The instrument panel carrier according to claim 1, characterized in that the connecting strut (3) has its lowest transverse section modulus in the region of the first connecting portion (6) or adjacent thereto.

3. The instrument panel carrier according to any one of claim 1 or 2, characterized in that the first connecting portion (6) is significantly narrower than the length of the connecting strut (3) between the transverse member (2) and its connection (9) to an end wall.

4. The instrument panel carrier according to any one of claims 1 to 3, characterized in that the cross section of the connecting strut (3) widens in the transverse direction in its direction pointing away from the transverse support.

5. The instrument panel carrier according to any one of claims 1 to 4, characterized in that the base region (11) of the connecting strut (3) extending in the transverse direction has a framework structure.

6. The instrument panel carrier according to any one of claims 1 to 5, characterized in that the connection of the connecting strut (3) to the transverse member (2) is offset in the transverse direction with respect to its connection (9) to the end wall.

7. The instrument panel carrier according to claim 6, characterized in that the connection (9) to the end wall is offset in the direction towards the center of the transverse member (2) in relation to its connection to the transverse member (2).

8. The instrument panel carrier according to any one of claims 1 to 7, characterized in that at least one connection point (18.1, 18.2) for the steering column is provided in the region of the second connecting portion (8) of the connecting strut (3).

9. The instrument panel carrier according to claim 8, characterized in that in the longitudinal extent of the connecting strut (3) the second connecting portion (8) is adjoined by a steering column connecting region (19) in which the at least one connecting point (18.1, 18.2) for the steering column is provided, and the remaining part (21) of the connecting strut (3) adjoins it and in that the second connecting portion (8) and the steering column connecting region (19) are reinforced together by a stiffening structure (20) in relation to the remaining part (21).

10. The instrument panel carrier according to claim 9, characterized in that the stiffening structure (20) is formed by walls (12, 23, 24, 24.1) connected to one another, which form a frame surrounding the at least one connection point (18.1, 18.2) for the steering column and wherein the end wall can be connected to one of the walls (24) of the stiffening structure (20).

11. The instrument panel carrier according to claim 10, characterized in that the connecting strut (3) is essentially formed by an L-profile, that a stiffening part (22) formed by two legs (24, 24.1) and a web (23) is provided as part of the stiffening structure (20) and that the further wall of the stiffening structure (20) is provided by a portion of the leg (12) of the L-profile and that the reinforcement part (22) is welded to the connecting strut (3).

12. The instrument panel carrier according to any one of claims 1 to 11, characterized in that the first connection region (6) is designed as a transverse member receptacle (7).

13. The instrument panel carrier according to any one of claims 1 to 12, characterized in that at least one connection point (18) for the steering column is provided in the region of the first connecting portion.
